(19) United States
(12) Patent Application Publication
(10) Pub. No.: US 2005/0254205 A1
(43) Pub. Date: Nov. 17, 2005

(54) Structure of flash slot

(76) Inventor: Chzh-Lin Jao, Ta Ping Village (TW)

Correspondence Address: DAVID E. DOUGHERTY;Dennison, Schultz, Dougherty & MacDonald, Suite 105, 1727 King Street, Alexandria, VA, 22314-2700, US

(21) Appl. No.: 10/846,656

(22) Filed: May 17, 2004

(51) Int. Cl. G06F 1/16

(52) U.S. Cl. 361/683

(57) ABSTRACT

An improved structure of a flash slot having a slot body and a liquid decorating substrate. The slot body is a housing structure and an outer edge thereof has a plurality of hubs for plugging in flash cards or flash memory cards. The plurality of hubs are connected to a host computer by an extension line of USB (Universal Serial Bus) type. The liquid decorating substrate is deposited on the slot body to and comprises a transparent container in which a variety of liquid decorating objects can settle.

### BACKGROUND OF THE INVENTION

The present invention relates to an improved structure of a flash slot, and more specifically, to a slot body with hubs that have a plurality of flash cards disposed under a liquid decorating substrate so that when put on a writing desk, flash cards can be easily plugged in and the decorating effects of the writing desk can be improved.

Desktop PCs are still the mainstream when using computers in offices. However, common CPUs of PCs are larger, so people always place them under writing desks and have a front side, with plugging slots for things like FD or CD, face the users. The relative hubs at a back side of the host, comprising connecting slots for mice, keyboards., power lines, flash cards, or flash memory cards (such as flash memory cards for digital cameras) are facing the inner side. However, according to the usages of flash cards or (flash memory cards for digital cameras) are used frequently and exchanged often in using recently. It easily causes trouble to users. Although a USB slot in the market can be used for flash cards or flash memory cards extended from the PC host to the writing desk, the USB slot only has a structure with single hub, so it is still inconvenient. Furthermoremore, it sits on the writing desk but has no other use, which adds confusions to the arrangement of the desk.

### SUMMARY OF THE INVENTION

The main object of the present invention is providing an improved structure of a flash slot comprising a slot body and a liquid decorating substrate. The slot body is a housing structure and an outer edge thereof, which has a plurality of hubs for plugging in flash cards or other types of flash memory cards. The plurality of hubs is connected to a host of a computer by a USB (Universal Serial Bus) plug. Furthermoremore, the liquid decorating substrate is deposited on the slot body to become one flesh with it and comprises a liquid enclosed container in which a variety of liquid decorating objects, such as bi-liquid floating objects can settle. The upper side of the container can have slots or holes to have functions like penholders or loaders. While placed on the writing desk and being used, it can be plugged into flash cards or flash memory cards or stationeries simply for users, as well as improve the dynamic decorating effects of liquid on the writing desk to achieve multi-purposes.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a stereo diagram of an embodiment of the present invention.

FIG. 2 is a stereo diagram of another embodiment of the present invention.

FIG. 3 is a stereo diagram of a Furthermore embodiment of the present invention.

FIG. 4 is a stereo diagram of the present invention connecting to a host of a desktop PC.

FIG. 5 is a stereo diagram of using status of the present invention.

### DETAILED DESCRIPTION OF THE PREFFERED EMBODIMENT

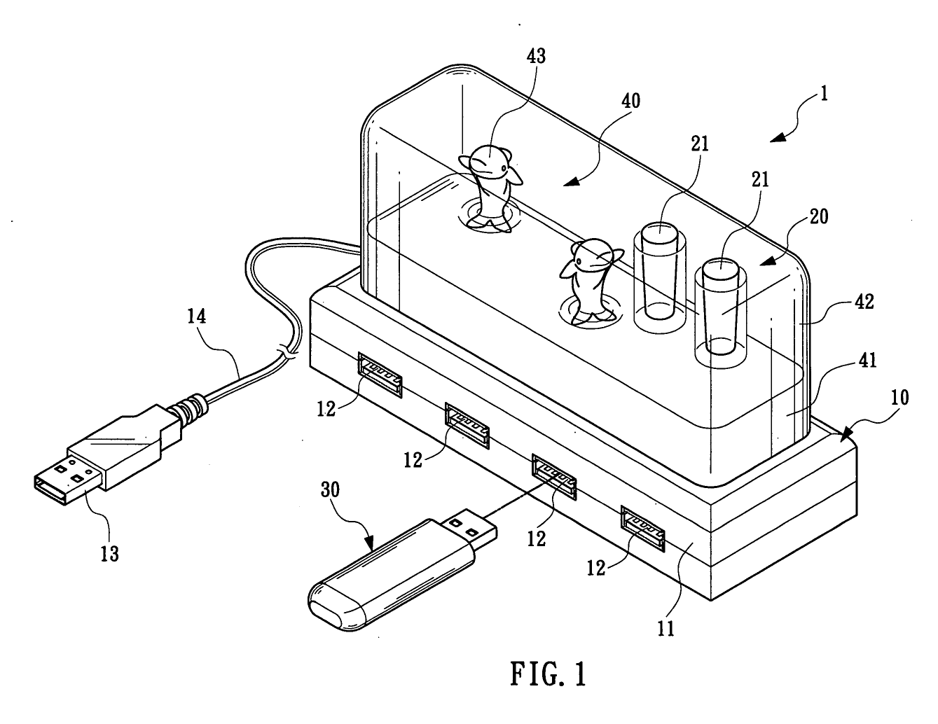

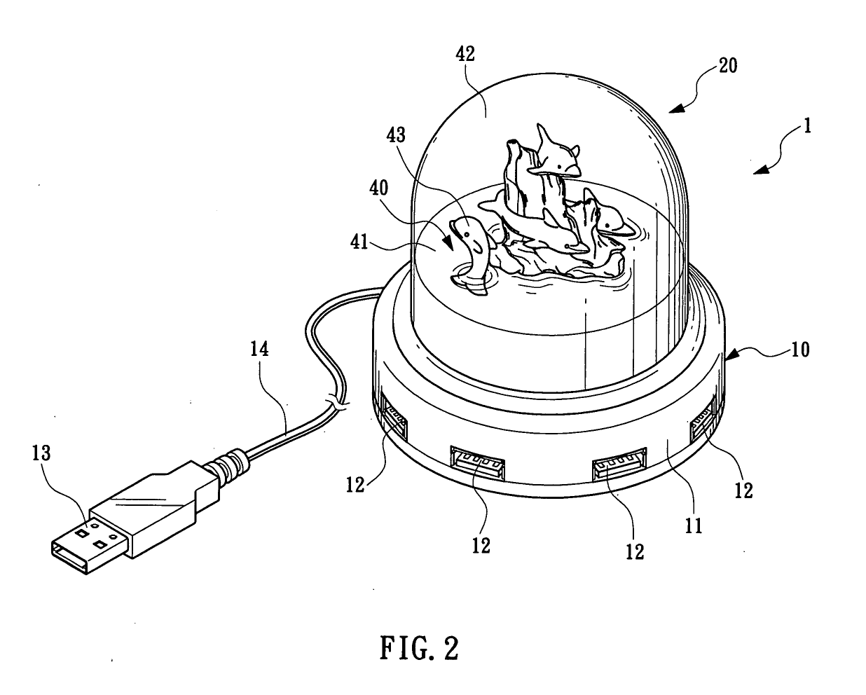

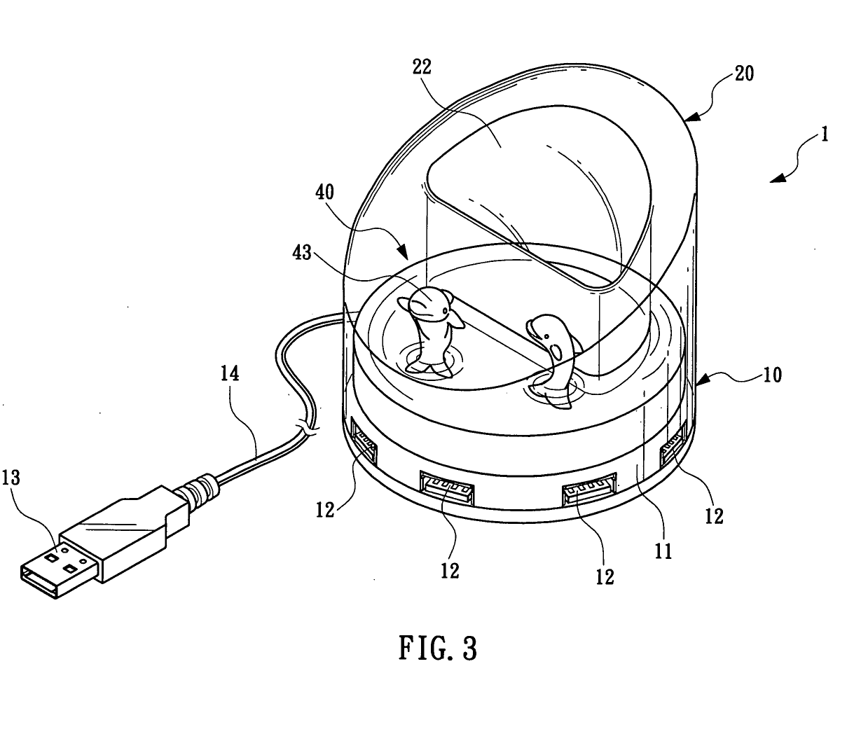

As shown in FIGS. 1, 2, and 3, the flash slot 1 of the present invention comprises a flash slot body 10 and a liquid decorating substrate 20 wherein the slot body 10 is a housing structure. Its shape is not limited, it can be a flat rectangular block as shown in FIG. 1, or a flat cylinder as shown in FIGS. 2 and 3. Furthermore, a plurality of hubs 12 are set on an outer edge 11 of the slot body 10.

The plurality of hubs 12 are better to face to the same direction; for example, four hubs are set as shown in FIGS. 1, 2 and 3. As shown in FIG. 1, they are set at a front side of the flat rectangular block. As shown in FIGS. 2 and 3, they are set at a front half arc surface of the flat cylinder. The plurality of hubs 12 can be plugged into flash cards 30 or alike. The slot body 10 is connected to a host of a computer (not shown in FIGS. 1, 2 and 3) by an extension line 14 with a USB (Universal Serial Bus) plug 13 so that the plurality of hubs 12 can be plugged into flash cards 30 or the like for forming a connection with the host of the computer. The extension line 14 is better to be set on an opposite surface (facing in the same direction) to the hubs.

The liquid decorating substrate 20 is deposited on the slot body 10 to become one flesh with the slot body 10. The connection method is not limited, such as sticking, locking, etc. The liquid decorating substrate 20 is mainly a transparent enclosed container with no limited shapes and can be designed in accordance to the slot body 20, such as a rectangular block container as shown in FIG. 1, a hemisphere container as shown in FIG. 2, or a cylinder container with a tilt cross-section as shown in FIG. 3. In the liquid decorating substrate 20, a variety of liquid decorating objects can be settled, including a bi-liquid floating object 40 as shown. The bi-liquid floating object 40 comprises a first liquid 41 with a bigger proportion (such as water), a second liquid 42 with a smaller proportion (such as oil), and floating objects 43 which can float between an interface of the first liquid 41 and the second liquid 42. The number of the floating objects 43 is not limited, and the shapes thereof can also vary. Besides, the upward out side of the container of the liquid decorating substrate 20 can furthermore have holes 21 or slots 22 for functioning as penholders or cell-phone holders as well.

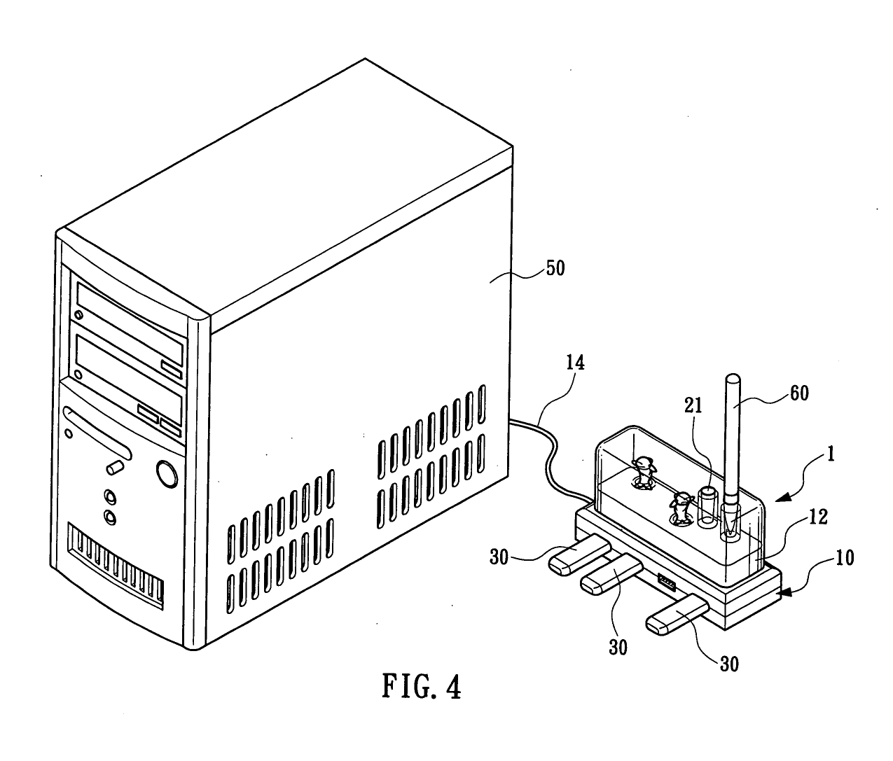

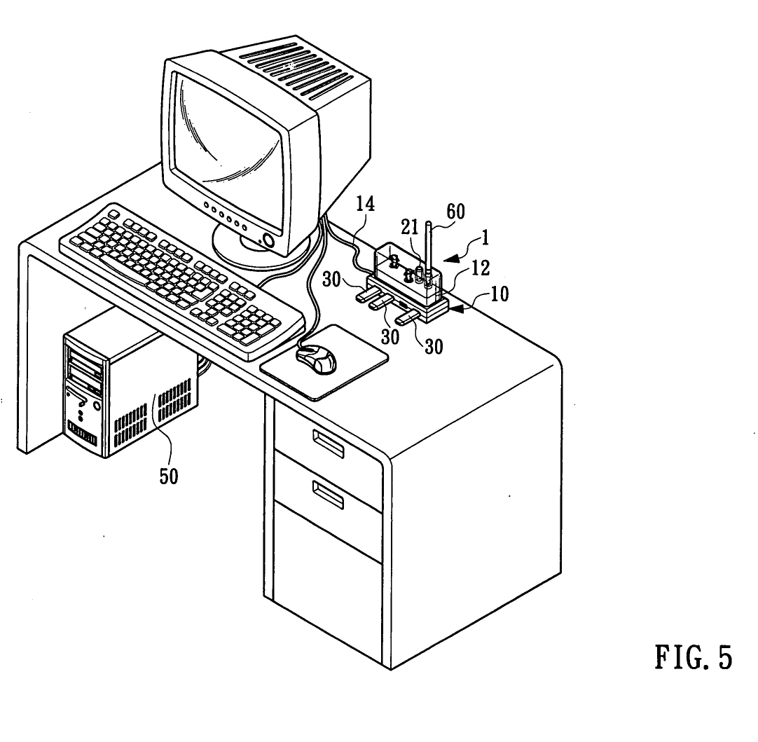

While using, as shown in FIG. 4, the flash slot 1 of the present invention plugs into a corresponding slot of a computer host 50 by its USB plug 13 first so that the plurality of hubs 12 on the flash slot 1 are all connected to the computer host and so on. Then by the extension line 14, the flash slot 1 can be placed on a proper position on the writing desk, as shown in FIG. 5 so that users can simply plug in flash cards 30 or flash memory cards into each hub 12 to perform processing and accessing data, or plugging pens 60 into the holes 21. According to the above side of the slot body 10 of the flash slot 1 also has the liquid decorating substrate 20, even if the flash slot 1 is in static or in dynamic mode since exchanging the flash cards 30, the liquid decorating substrate 20 and each kind of liquid decorating objects therein can be shown outward at an outstanding position to improve the decorating effects of the writing desk so that the flash slot 1 can have multi-purposes.

1. An improved structure of a flash slot comprising:
a flash slot body having a substantially rectangular configuration with an upper surface and an outer edge,
a liquid container having substantially the same shape and configuration as said flash slot body and being integrally disposed on said upper surface,
a plurality of hubs is disposed along said outer edge of said flash slot body for plugging in a plurality of flash cards at the same time, and the slot body is connected to a host of a computer by an extension line with a USB plug for forming a connection with the host of the computer;
the liquid container comprises a plurality of object receiving openings on an outer casing thereof;
the flash slot can be connected to the host of the computer by the aforementioned structure and can be placed at an appropriate position on a writing desk so that users can plug flash cards into each hub and so that the liquid decorating substrate thereof and the liquid decorating objects thereof can be shown outward in an outstanding direction to improve decorating effects of the writing desk.

2. The improved structure of the flash slot of claim 1, wherein the plurality of hubs deposited on the outer edge of the slot body are preferred facing to the same direction.

3. The improved structure of the flash slot of claim 1, wherein the extension line is preferred deposited at an opposite side from the hubs.

4. The improved structure of the flash slot of claim 1, wherein the plurality of hubs can accept other types of flash memory cards.

5. The improved structure of the flash slot of claim 1, wherein the liquid decorating objects in the transparent enclosed container comprises a kind of bi-liquid floating object, the bi-liquid floating object comprises a first liquid with a bigger portion, a second liquid with a smaller proportion, and floating objects able to float between an interface of the first liquid and the second liquid.
